(19) United States
(12) Patent Application Publication
(10) Pub. No.: US 2019/0177665 A1
(43) Pub. Date: Jun. 13, 2019

(54) LIQUID LAUNDRY FORMULATION

(71) Applicant: BASF SE, Ludwigshafen am Rhein (DE)

(72) Inventors: Oliver Spangenberg, Ludwigshafen (DE); Claudia Esper, Ludwigshafen (DE)

(21) Appl. No.: 16/324,304

(22) PCT Filed: Jul. 31, 2017
(86) PCT No.: PCT/EP2017/069299

§ 371 Date: Feb. 8, 2019

(30) Foreign Application Priority Data
Aug. 8, 2016 (EP) 16183172.2

(51) Int. Cl. C11D 3/386; C11D 11/00; C11D 3/33; C11D 3/37

(52) U.S. Cl. CPC C11D 3/38618; C11D 11/0017; C11D 3/3719; C11D 3/3723; C11D 3/33

(57) ABSTRACT

A method for removing stain or soil from laundry, including contacting the laundry with a laundry detergent composition including an aminocarboxylate builder or co-builder, a polymer, and a protease. The aminocarboxylate may be methylglycine diacetate (MGDA), iminodisuccinic acid (IDS), glutamic acid diacetate (GLDA), ethylenediaminedisuccinic acid (EDDS), polyasparatic acid, and associated salts. The polymer may be an ethoxylated polyethylenimin with an average molecular weight from 3,000 to 250,000 g/mol having 80 to 99% by weight ethylene oxide side chains, based on total ethoxylated polyethylenimine, and/or an ethoxylated hexamethylene diamine, quaternized and optionally sulfated with an average molecular weight from 2,000 to 10,000 g/mol. The disclosure further relates to the use of such compositions for removing stain or soil from laundry, to such laundry compositions themselves and their manufacturing process, as well as to methods of improving stain-removal ability of a protease in laundry detergent compositions.

The present invention relates to a method for removing stain or soil from laundry, comprising contacting the laundry with a composition comprising:
(a) at least one builder or co-builder which is an aminocarboxylate selected from the group consisting of methylglycine diacetate (MGDA), iminodisuccinic acid (IDS), glutamic acid diacetate (GLDA), and ethylenediaminedisuccinic acid (EDDS), polyasparatic acid, and salts thereof;
(b) a polymer which is
   (b1) an ethoxylated polyethylenimine with an average molecular weight M_{w} in the range from 3000 to 250.000 g/mol which has 80 to 99% by weight ethylene oxide side chains, based on total ethoxylated polyethylenimine, and/or
   (b2) a polymer which is an ethoxylated hexamethylene diamine, quaternized and optionally sulfated with an average molecular weight M_{w} in the range from 2000 to 10,000 g/mol and mixtures thereof; and
(c) a protease.

The present invention also relates to the use of such compositions for removing stain or soil from textiles, to such laundry detergent compositions themselves and their manufacturing process, as well as to methods of improving stain-removal performance of a protease in laundry compositions.

Laundry detergent compositions have to fulfil numerous requirements. They are not only required to work with calcium- and magnesium-free water but also with hard water. They should be environmentally friendly; the use of phosphates as builder to reduce water hardness and to provide alkalinity is no more allowed in Western geographies. Additionally, they need to provide a certain shelf life to assure wash performance goals are met after ageing. Also, they are required to have excellent cleaning properties for various soiling of laundry including the removal of bleach-sensitive and protease-sensitive stains, including stains from organic material such as, e.g., fruit stains from berries, grass, blood, milk, or cocoa. Particularly removal of bleach-sensitive stains and soil is critical as most bleach additives are not stable in many laundry detergent formulations, e.g., in particular in liquid laundry detergent formulations.

Numerous organic chelating agents such as the alkali metal salts of MGDA and of GLDA have been developed as environmentally friendly chelating agents. These and others like zeolite or silicates/carbonates can replace most of the phosphate or even all of the phosphate in cleaning agents.

It can be observed, though, that many laundry detergents lose their soil removal efficacy after some time of storage. Especially liquid laundry detergent compositions exhibit only minor activity after a few weeks of storage at elevated temperature of 30° C. or even higher temperatures, for example 35° C. or 37° C. Such temperatures are not only quite common in Southern European or Southern American countries and South-east Asia but also in laundering facilities. In addition, particularly in liquid laundry detergent compositions, bleach additives are not stable and thus usually not used in liquid formulations.

Without to be bound to any theory it is believed that strong complexing agents may extract the central Ca²⁺ metal ion(s) of the active site(s) of detergent proteases and amylases, thus, reduce the activity of said enzymes.

The present invention addresses these technical problems and provides a solution as further described herein and as defined in the claims.

The present invention relates to a method for removing stain or soil from laundry, comprising contacting the laundry with a laundry detergent composition comprising:
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid, and the respective salts thereof (herein also referred to as “builder or co-builder (a)” or “component (a)”);
(b) a polymer (hereinafter also referred to as “polymer (b)” or “component (b)”) which is
   (b1) an ethoxylated polyethylenimine with an average molecular weight M_{w} in the range from 3,000 to 250,000 (preferably 5,000 to 20,0000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (b1)” or “component (b1)”), and/or
   (b2) a polymer which is an ethoxylated hexamethylene diamine, quaternized and optionally sulfated with an average molecular weight M_{w} in the range from 2,000 to 10,000 g/mol, more preferably 3,000-8,000, most preferably 4,000-6,000, and mixtures thereof (hereinafter also referred to as “polymer (b2)” or “component (b2)”); and
(c) a protease (herein also referred to as “protease (c)” or “component (c)”).

The present invention also relates to the use of a laundry detergent composition for removing stains or soil from laundry said composition comprising
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid, and the respective salts thereof (herein also referred to as “builder or co-builder (a)” or “component (a)”);
(b) a polymer (hereinafter also referred to as “polymer (b)” or “component (b)”) which is
   (b1) an ethoxylated polyethylenimine with an average molecular weight M_{w} in the range from 3,000 to 250,000 (preferably 5,000 to 20,0000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (b1)” or “component (b1)”), and/or
   (b2) a polymer which is an ethoxylated hexamethylene diamine, quaternized and optionally sulfated with an average molecular weight M_{w} in the range from 2,000 to 10,000 g/mol, more preferably 3,000-8,000, most preferably 4,000-6,000, and mixtures thereof (hereinafter also referred to as “polymer (b2)” or “component (b2)”); and
(c) a protease (herein also referred to as “protease (c)” or “component (c)”).

The present invention also relates to a laundry detergent composition for removing stain or soil from laundry, said composition comprising:
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid, and the respective salts thereof (herein also referred to as “builder or co-builder (a)” or “component (a)”);
(b) a polymer (hereinafter also referred to as “polymer (b)” or “component (b)”) which is
   (b1) an ethoxylated polyethylenimine with an average molecular weight M_{w} in the range from 3,000 to 250,000 (preferably 5,000 to 20,0000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (b1)” or “component (b1)”), and/or
   (b2) a polymer which is an ethoxylated hexamethylene diamine, quaternized and optionally sulfated with an average molecular weight M_{w} in the range from 2,000 to 10,000 g/mol, more preferably 3,000-8,000, most preferably 4,000-6,000, and mixtures thereof (hereinafter also referred to as “polymer (b2)” or “component (b2)”); and
(c) a protease (herein also referred to as “protease (c)” or “component (c)”).

The present invention also relates to a method of improving stain-removal ability of a protease (herein also referred to as “protease (c)” or “component (c)”) in laundry detergent compositions, said method comprising the step of adding
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid, and the respective salts thereof (herein also referred to as “builder or co-builder (a)” or “component (a)”); and
(b) a polymer (hereinafter also referred to as “polymer (b)” or “component (b)”) which is
   (b1) an ethoxylated polyethylenimine with an average molecular weight M_{w} in the range from 3,000 to 250,000 (preferably 5,000 to 20,0000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (b1)” or “component (b1)”), and/or
   (b2) a polymer which is an ethoxylated hexamethylene diamine, quaternized and optionally sulfated with an average molecular weight M_{w} in the range from 2,000 to 10,000 g/mol, more preferably 3,000-8,000, most preferably 4,000-6,000, and mixtures thereof (hereinafter also referred to as “polymer (b2)” or “component (b2)”); and
      to said protease.

The present invention also relates to the use of a laundry detergent composition comprising
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid, and the respective salts thereof (herein also referred to as “builder or co-builder (a)” or “component (a)”);
(b) a polymer (hereinafter also referred to as “polymer (b)” or “component (b)”) which is
   (b1) an ethoxylated polyethylenimine with an average molecular weight M_{w} in the range from 3,000 to 250,000 (preferably 5,000 to 20,0000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (b1)” or “component (b1)”), and/or
   (b2) a polymer which is an ethoxylated hexamethylene diamine, quaternized and optionally sulfated with an average molecular weight M_{w} in the range from 2,000 to 10,000 g/mol, more preferably 3,000-8,000, most preferably 4,000-6,000, and mixtures thereof (hereinafter also referred to as “polymer (b2)” or “component (b2)”); and
      to improve the stain-removal ability of a protease (herein also referred to as “protease (c)” or “component (c)”) in laundry compositions.

The present invention also relates to a method of preparing a laundry detergent composition as provided and defined herein, comprising mixing
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid, and the respective salts thereof (herein also referred to as “builder or co-builder (a)” or “component (a)”);
(b) a polymer (hereinafter also referred to as “polymer (b)” or “component (b)”) which is
   (b1) an ethoxylated polyethylenimine with an average molecular weight M_{w} in the range from 3,000 to 250,000 (preferably 5,000 to 20,0000, more preferably 8,000 to 100,000, more preferably 8,000 to 50,000, more preferably 10,000 to 30,000, and most preferably 10,000 to 20,000) g/mol which has 80 to 99% (preferably 85 to 99%, more preferably 90 to 98%, most preferably 93 to 97% or 94 to 96%) by weight ethylene oxide side chains, based on total ethoxylated polyethylenimine (hereinafter also referred to as “polymer (b1)” or “component (b1)”), and/or
   (b2) a polymer which is an ethoxylated hexamethylene diamine, quaternized and optionally sulfated with an average molecular weight M_{w} in the range from 2,000 to 10,000 g/mol, more preferably 3,000-8,000, most preferably 4,000-6,000, and mixtures thereof (hereinafter also referred to as “polymer (b2)” or “component (b2)”); and
(c) a protease (herein also referred to as “protease (c)” or “component (c)”) in one or more steps.

As has surprisingly been found in context with the present invention and as shown and exemplified herein, a laundry detergent composition comprising a builder or co-builder (a), a polymer (b), and a protease (c) as further described and exemplified herein is not only environmentally friendly but particularly exhibits superior abilities for removing bleach-sensitive and protease-sensitive soil and stains from laundry. That is, as has been found in context with the present invention, the mixture of said particular components (a), (b), and (c) leads to synergistic effects, i.e. the soil and stain removal abilities of such compositions comprising (a), (b), and (c) are higher than could be expected by the single abilities of (a), (b), and (c) alone. Particularly, the inventive laundry detergent composition comprising (a), (b), and (c) as described and provided by the present invention exhibits not only superior effects for removing protease-sensitive stains, but particularly bleach-sensitive stains, even without the addition of bleach agents. This surprising effect bears inter alia great advantages for the preparation of laundry detergent compositions which do not allow long shelf-life of bleach agent-containing compositions, e.g., liquid laundry detergent compositions.

As used herein, the terms “stain(s)” or “soil” are used synonymously and comprise any kind of dirt on laundry.

As used herein, the term “laundry” comprises all kinds of textile and fabrics, and “laundry” or “laundry cleaning” particularly comprises home care laundry (fabrics, textile) as well as industrial and institutional (“I&I”) textile (fabrics) cleaning.

As used herein, the terms “comprise”, “comprising”, etc. are used interchangeably with “contain”, “containing”, etc. and are to be interpreted in a non-limiting, open manner. That is, e.g., further compounds may be present. However, such terms also encompass variations in the meaning of “consist of” or “consisting of”, etc., where the interpretation is of limiting nature and no further compounds are present, at least not in substantial or effective amounts.

The following descriptions and embodiments, particularly those of components (a), (b) and (c), apply mutatis mutandis to all methods, uses and compositions provided by the present invention.

Generally, in context with the present invention, the builder (a) may be present in an amount of 0.1 to 25.0 w/w %, preferably 1.0 to 18.0 w/w %, preferably 3.0 to 15.0 w/w %, preferably 3.0 to 10.0 w/w %, preferably 5.0 to 9.0w/w %, preferably 5.0 to 8.0 w/w %, relative to the total weight of the laundry detergent composition.

In one embodiment of the present invention, the salts of methylglycine diacetate (MGDA), iminodisuccinic acid (IDS), glutamic acid diacetate (GLDA), ethylenediaminedisuccinic acid (EDDS), polyasparatic acid as defined as builder or co-builder (a) are alkali metal salts of said aminocarboxylates. In this context, alkali metal salts may be selected from inter alia lithium salts, potassium salts and sodium salts. For example, the alkali metal salts are potassium salts or sodium salts, e.g., sodium salts.

In one embodiment of the present invention, alkali metal salts of MGDA are selected from those of general formula (I)

[CH₃—CH(COO)—N(CH₂—COO)₂]Na_{3-x-y}KₓH_{y} (I)
x being selected from 0.0 to 0.5, preferably up to 0.25,
y being selected from 0.0 to 0.5, preferably up to 0.25.

In one embodiment of the present invention, alkali metal salts of GLDA are selected from those of general formula (II)

[OOC—(CH₂)₂—CH(COO)—N(CH₂—COO)₂]Na_{4-x-y}KₓH_{y} (II)
x being selected from 0.0 to 0.5, preferably up to 0.25,
y being selected from 0.0 to 0.5, preferably up to 0.25.

In one embodiment of the present invention, alkali metal salts of MGDA may be selected from alkali metal salts of the L-enantiomer, of the racemic mixture and of enantiomerically enriched alkali metal salts of MGDA, with an excess of L-enantiomer compared to the D-enantiomer. Preference is given to alkali metal salts of mixtures from the L-enantiomer and the D-enantiomer in which the molar ratio of L/D is in the range of from 55:45 to 85:15. Such mixtures exhibit a lower hygroscopicity than, e.g., the racemic mixture. The enantiomeric excess can be determined, e.g., by measuring the polarization (polarimetry) or preferably by chromatography, for example by HPLC with a chiral column, for example with one or more cyclodextrins as immobilized phase. Preferred is determination of the enantiomeric excess by HPLC with an immobilized optically active ammonium salt such as D-penicillamine.

Alkali metal salts of GLDA may be selected from alkali metal salts of the L-enantiomer, of the racemic mixture and of enantiomerically enriched GLDA, with an excess of L-enantiomer compared to the D-enantiomer. Preference is given to alkali metal salts of mixtures from L-enantiomer and D-enantiomer in which the molar ratio of L/D is in the range of from 80:20 or higher, preferably of from 85:15 up to 99:1. Such alkali metal salts of GLDA have a better biodegradability than, e.g., the racemic mixture or the pure D-enantiomer. The enantiomeric excess can be determined, e.g., by measuring the polarization (polarimetry) or preferably by chromatography, for example by HPLC with a chiral column, for example with one or more cyclodextrins as immobilized phase. Preferred is determination of the enantiomeric excess by HPLC with an immobilized optically active ammonium salt such as D-penicillamine.

Generally, in context with the present invention, small amounts (e.g., 0.01 to 5 mol-% of total builder (a)) of builder (a) may also bear a cation other than alkali metal. It is thus possible that small amounts, such as 0.01 to 5 mol-% of total builder (a) may bear alkali earth metal cations such as, e.g., Mg²⁺ or Ca²⁺, or a transition metal cation such as, e.g., a Fe²⁺ or Fe³⁺ cation.

In one embodiment of the present invention, builder (a) may contain one or more impurities that may result from the production of the respective builder. In the case of MGDA and its alkali metal salts, such impurities may be selected from inter alia alkali metal propionate, lactic acid, alanine, or the like. Such impurities are usually present in small amounts. In the context of the present invention, such small amounts may be neglected when determining the composition of builder (a). In the case of GLDA and its alkali metal salts, such impurities may be selected from inter alia alkali glutamine monoacetic acid trisodium salt, glycolate, and formate. For IDS, EDDS, or polyaspartic acid, similar impurities are typical.

“Small amounts” in this context refer to a total of 0.1 to 1 w/w %, referring to the respective builder or co-builder (a).

As mentioned, the builder, co-builder (a) may be present in an amount of 0.1 to 25.0 w/w %, preferably 1.0 to 18.0 w/w %, preferably 3.0 to 15.0 w/w %, preferably 3.0 to 10.0 w/w %, preferably 5.0 to 9.0 w/w or 5.0 to 8.0 w/w %, referring to the total solid content weight of relative to the total weight of the laundry detergent composition.

In one embodiment, the composition provided and described herein comprises in total in the range of from 0.1 to 25.0 w/w %, preferably 1.0 to 18.0 w/w %, preferably 3.0 to 15.0 w/w %, preferably 3.0 to 10.0 w/w %, preferably 5.0 to 9.0w/w or 5.0 to 8.0 w/w %, of at least one aminocarboxylate selected from methylglycine diacetate (MGDA), iminodisuccinic acid (IDS), glutamic acid diacetate (GLDA), ethylenediaminedisuccinic acid (EDDS), polyasparatic acid, and the respective salts thereof, e.g., alkali (such as sodium) salts thereof as defined and described herein.

In a specific embodiment of the present invention, the builder (a) is MGDA or GLDA, preferably MGDA.

Ethoxylated polyethylenimine according to polymer (b1) of the present invention is based on a polyethylene core and a polyethylene oxide shell. Suitable polyethylene imine core molecules are polyethylene imines with average molecular weight M_{w} in the range of 500 to 5000 g/mol. Preferred is a molecular weight from 500 to 1000 g/mol, even more preferred is an M_{w} of 600-800 g/mol. The ethoxylated polymer (b1) then has in average 5 to 50, preferably 10 to 30 and even more preferably 15 to 25 EO (ethoxylate) groups per —NH group, resulting in an average molecular weight M_{w} in the range from 3,000 to 250,000 (preferably 5,000 to 20,0000, more preferably 8,000 to 100,000, more preferably 8,000 to 50,000, more preferably 10,000 to 30,000, and most preferably 10,000 to 20,000) g/mol.

Ethoxylated hexamethylene diamine, quaternized and optionally sulfated according to polymer (b2) of the present invention contains in average 10 to 50, preferably 15 to 40 and even more preferably 20 to 30 EO (ethoxylate) groups per —NH group, resulting in an average molecular weight M_{w} in the range from 2,000 to 10,000 g/mol, more preferably 3,000-8,000, most preferably 4,000-6,000. In one embodiment of the present invention, the ethoxylated hexamethylene diamine is quaternized and also sulfated, preferably bearing 2 cationic ammonium groups and 2 anionic sulfate groups.

In context with the present invention, the polymer (b) may be present in an amount of 0.1 to 10 w/w %, relative to the total weight of the laundry detergent composition, preferably 0,3 to 8, 0,5 to 5, 1 to 5 or 2 to 5w/w %.

In context with the present invention, component (c) is a protease. In this context, the term “protease” means enzymes that perform proteolysis, i.e. that hydrolyse the peptide bonds that link amino acids together in the polypeptide chain forming the protein. Methods for determining protease activity are known in the art (see e.g. Gupta et al. (2002), Appl. Microbiol. Biotechnol. 60: 381-395). For example, proteolytic activity as such can be determined by using Succinyl-Ala-Ala-Pro-Phe-p-nitroanilide (Suc-AAPF-pNA, short AAPF; see e.g. DelMar et al. (1979), Analytical Biochem 99, 316-320) as substrate. pNA is cleaved from the substrate molecule by proteolytic cleavage, resulting in release of yellow color of free pNA which can be quantified by measuring OD₄₀₅. Other suitable methods are known to those skilled in the art.

Enzymes having proteolytic activity are called “protease” (component (c)) or peptidases in the context of the invention and are preferably members of class EC 3.4. In the following, the term “protease” as used in context with the present invention will be further specified and include embodiments which are inter alia particularly suitable to be employed in context with the present invention.

Proteases are further classified as aminopeptidases (EC 3.4.11), dipeptidases (EC 3.4.13), dipeptidyl-peptidases and tripeptidyl-peptidases (EC 3.4.14), peptidyl-dipeptidases (EC 3.4.15), serine-type carboxypeptidases (EC 3.4.16), metallocarboxypeptidases (EC 3.4.17), cysteine-type carboxypeptidases (EC 3.4.18), omega peptidases (EC 3.4.19), serine endopeptidases (EC 3.4.21), cysteine endopeptidases (EC 3.4.22), aspartic endopeptidases (EC 3.4.23), metallo-endopeptidases (EC 3.4.24), threonine endopeptidases (EC 3.4.25), endopeptidases of unknown catalytic mechanism (EC 3.4.99).

The protease in the context of the present invention may be an endopeptidase of any kind or a mixture of endopeptidases of any kind, especially it may be a serine protease (EC 3.4.21). A serine protease according to the invention is selected from the group consisting of chymotrypsin (e.g., EC 3.4.21.1), elastase (e.g., EC 3.4.21.36), elastase (e.g., EC 3.4.21.37 or EC 3.4.21.71), granzyme (e.g., EC 3.4.21.78 or EC 3.4.21.79), kallikrein (e.g., EC 3.4.21.34, EC 3.4.21.35, EC 3.4.21.118, or EC 3.4.21.119,) plasmin (e.g., EC 3.4.21.7), trypsin (e.g., EC 3.4.21.4), thrombin (e.g., EC 3.4.21.5,) and subtilisin (also known as subtilopeptidase, e.g., EC 3.4.21.62), the latter hereinafter also being referred to as “subtilisin”. Serine proteases or serine peptidases are characterized by having a serine in the catalytically active site, which forms a covalent adduct with the substrate during the catalytic reaction.

Crystallographic structures of proteases show that the active site is commonly located in a groove on the surface of the molecule between adjacent structural domains, and the substrate specificity is dictated by the properties of binding sites arranged along the groove on one or both sides of the catalytic site that is responsible for hydrolysis of the scissile bond. Accordingly, the specificity of a protease can be described by use of a conceptual model in which each specificity subsite is able to accommodate the sidechain of a single amino acid residue. The sites are numbered from the catalytic site, S1, S2 . . . Sn towards the N-terminus of the substrate, and 51′, S2′ . . . Sn′ towards the C-terminus. The residues they accommodate are numbered P1, P2 . . . Pn, and P1′, P2′ . . . Pn′, respectively:

| | | | | | | | |
|---|---|---|---|---|---|---|---|
| Substrate | P3 | P2 | P1 | + | P1′ | P2′ | P3′ |
| Enzyme | S3 | S2 | S1 | * | S1′ | S2′ | S3′ |

In this representation the catalytic site of the enzyme is marked “*” and the peptide bond cleaved (the scissile bond) is indicated by the symbol “+”.

In general, the three main types of protease activity are: trypsin-like, where there is cleavage of amide substrates following Arg (N) or Lys (K) at P1, chymotrypsin-like where cleavage occurs following one of the hydrophobic amino acids at P1, and elastase-like with cleavage following an Ala (A) at P1.

A sub-group of the serine proteases tentatively designated subtilases has been proposed by Siezen et al. (1991), Protein Eng. 4:719-737 and Siezen et al. (1997), Protein Science 6:501-523. They are defined by homology analysis of more than 170 amino acid sequences of serine proteases previously referred to as subtilisin-like proteases. A subtilisin was previously often defined as a serine protease produced by Gram-positive bacteria or fungi, and according to Siezen et al. now is a subgroup of the subtilases. A wide variety of subtilases have been identified, and the amino acid sequence of a number of subtilases has been determined. For a more detailed description of such subtilases and their amino acid sequences reference is made to Siezen et al. (1997), Protein Science 6:501-523.

The subtilases may be divided into 6 sub-divisions, i.e. the subtilisin family, thermitase family, the proteinase K family, the !antibiotic peptidase family, the kexin family and the pyrolysin family.

A subgroup of the subtilases are the subtilisins which are serine proteases from the family S8 as defined by the MEROPS database (http://merops.sanger.ac.uk). Peptidase family S8 contains the serine endopeptidase subtilisin and its homologues. In subfamily S8A, the active site residues frequently occurs in the motifs Asp-Thr/Ser-Gly (which is similar to the sequence motif in families of aspartic endopeptidases in clan AA), His-Gly-Thr-His and Gly-Thr-Ser-Met-Ala-Xaa-Pro. Most members of the family are active at neutral-mildly alkali pH. Many peptidases in the family are thermostable. Casein is often used as a protein substrate and a typical synthetic substrate is Suc-Ala-Ala-Pro-Phe-NHPhNO_{2.}

Prominent members of family S8, subfamily A are:

| name | MEROPS Family S8, Subfamily A |
|---|---|
| Subtilisin Carlsberg | S08.001 |
| Subtilisin lentus | S08.003 |
| Thermitase | S08.007 |
| Subtilisin BPN′ | S08.034 |
| Subtilisin DY | S08.037 |
| Alkaline peptidase | S08.038 |
| Subtilisin ALP 1 | S08.045 |
| Subtilisin sendai | S08.098 |
| Alkaline elastase YaB | S08.157 |

The subtilisin related class of serine proteases shares a common amino acid sequence defining a catalytic triad which distinguishes them from the chymotrypsin related class of serine proteases. Subtilisins and chymotrypsin related serine proteases both have a catalytic triad comprising aspartate, histidine and serine.

In the subtilisin related proteases the relative order of these amino acids, reading from the amino to carboxy-terminus is aspartate-histidine-serine. In the chymotrypsin related proteases the relative order, however is histidine-aspartate-serine. Thus, subtilisin herein refers to a serine protease having the catalytic triad of subtilisin related proteases. Examples include the subtilisins as described in WO 89/06276 and EP 0283075, WO 89/06279, WO 89/09830, WO 89/09819, WO 91/06637 and WO 91/02792.

Wild-type proteases of the subtilisin type (EC 3.4.21.62) and variants may be bacterial proteases. Said bacterial protease may be a Gram-positive bacterial polypeptide such as a Bacillus, Clostridium, Enterococcus, Geobacillus, Lactobacillus, Lactococcus, Oceanobacillus, Staphylococcus, Streptococcus, or Streptomyces protease, or a Gram-negative bacterial polypeptide such as a Campylobacter, E. coli, Flavobacterium, Fusobacterium, Helicobacter, Ilyobacter, Neisseria, Pseudomonas, Salmonella, or Ureaplasma protease. They act as unspecific endopeptidases, i.e. they hydrolyze any acid amide bonds located inside peptides or proteins. Their pH optimum is usually within the neutral to distinctly alkaline range. A review of this family is provided, for example, in “Subtilases: Subtilisin-like Proteases” by R. Siezen, pages 75-95 in “Subtilisin enzymes”, edited by R. Bott and C. Betzel, New York, 1996.

Commercially available protease enzymes include those sold under the trade names Alcalase®, Blaze®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® (Novozymes A/S), those sold under the tradename Maxatase®, Maxacal®, Maxapem®, Purafect®, Purafect® Prime, Purafect MA®, Purafect Ox®, Purafect OxP®, Puramax®, Properase®, FN2®, FN3®, FN4®, Excellase®, Eraser®, Ultimase®, Opticlean®, Effectenz®, Preferenz® and Optimase® (Danisco/DuPont), Axapem™, (Gist-Brocases N.V.), BLAP (sequence shown in FIG. 29 of U.S. Pat. No. 5,352,604) and variants hereof and KAP (Bacillus alkalophilus subtilisin) from Kao.

In one aspect of the invention, the wild-type and variants may be a Bacillus alcalophilus, Bacillus amyloliquefaciens, Bacillus brevis, Bacillus circulans, Bacillus clausii, Bacillus coagulans, Bacillus firmus, Bacillus gibsonii, Bacillus lautus, Bacillus lentus, Bacillus licheniformis, Bacillus megaterium, Bacillus pumilus, Bacillus sphaericus, Bacillus stearothermophilus, Bacillus subtilis, or Bacillus thuringiensis protease.

In one embodiment of the present invention, the subtilisin is a wild-type enzyme or a subtilisin variant, in which the wild-type enzyme or the starting enzyme variant is selected from the following:
subtilisin from Bacillus amyloliquefaciens BPN′ (described by Vasantha et al. (1984) J. Bacteriol. Volume 159, p. 811-819 and J A Wells et al. (1983) in Nucleic Acids Research, Volume 11, p. 7911-7925),
subtilisin from Bacillus licheniformis (subtilisin Carlsberg; disclosed in EL Smith et al. (1968) in J. Biol Chem, Volume 243, pp. 2184-2191, and Jacobs et al. (1985) in Nucl. Acids Res, Vol 13, p. 8913-8926),
subtilisin PB92 (original sequence of the alkaline protease PB92 is described in EP 283075 A2),
subtilisin 147 and/or 309 (Savinase®, Esperase®) as disclosed in GB 1243784,
subtilisin from Bacillus lentus as disclosed in WO 91/02792, preferably from Bacillus lentus DSM 5483 or the variants of Bacillus lentus DSM 5483 as described in WO 95/23221,
subtilisin from Bacillus alcalophilus (DSM 11233) disclosed in DE 10064983,
subtilisin from Bacillus gibsonii (DSM 14391) as disclosed in WO 2003/054184,
subtilisin from Bacillus sp. (DSM 14390) disclosed in WO 2003/056017,
subtilisin from Bacillus sp. (DSM 14392) disclosed in WO 2003/055974,
subtilisin from Bacillus gibsonii (DSM 14393) disclosed in WO 2003/054184,
subtilisin having SEQ ID NO: 4 as described in WO 2005/063974 or a subtilisin which is at least 40% identical thereto and having proteolytic activity,
subtilisin having SEQ ID NO: 4 as described in WO 2005/103244 or subtilisin which is at least 80% identical thereto and having proteolytic activity,
subtilisin having SEQ ID NO: 7 as described in WO 2005/103244 or subtilisin which is at least 80% identical thereto and having proteolytic activity, and
subtilisin having SEQ ID NO: 2 as described in application DE 102005028295.4 or subtilisin which is this at least 66% identical thereto and having proteolytic activity.

Examples of useful proteases in accordance with the present invention comprise the variants described in: WO 92/19729, WO 95/23221, WO 96/34946, WO 98/20115, WO 98/20116, WO 99/11768, WO 01/44452, WO 02/088340, WO 03/006602, WO 2004/03186, WO 2004/041979, WO 2007/006305, WO 2011/036263, WO 2011/036264, and WO 2011/072099. Suitable examples comprise especially protease variants of subtilisin protease derived from SEQ ID NO:22 as described in EP 1921147 (which is the sequence of mature alkaline protease from Bacillus lentus DSM 5483) with amino acid substitutions in one or more of the following positions: 3, 4, 9, 15, 24, 27, 33, 36, 57, 68, 76, 77, 87, 95, 96, 97, 98, 99, 100, 101 , 102, 103, 104, 106, 118, 120, 123, 128, 129, 130, 131, 154, 160, 167, 170, 194, 195, 199, 205, 206, 217, 218, 222, 224, 232, 235, 236, 245, 248, 252 and 274 (according to the BPN′ numbering), which have proteolytic activity. Preferably, such a subtilisin protease is not mutated at positions Asp32, His64 and Ser221 (according to BPN′ numbering).

In one embodiment, the subtilisin has SEQ ID NO: 22 as described in EP 1921147, or a subtilisin which is at least 80% identical thereto and has proteolytic activity. Preferably, a subtilisin is at least 80% identical to SEQ ID NO:22 as described in EP 1921147 and is characterized by having amino acid glutamic acid (E), or aspartic acid (D), or asparagine (N), or glutamine (Q), or alanine (A), or glycine (G), or serine (S) at position 101 (according to BPN′ numbering) and has proteolytic activity. Preferably, subtilisin is at least 80% identical to SEQ ID NO:22 as described in EP 1921147 and is characterized by having amino acid glutamic acid (E), or aspartic acid (D), at position 101 (according to BPN′ numbering) and has proteolytic activity. Such subtilisin variant may preferably comprise an amino acid substitution at position 101, preferably R101E or R101D, alone or in combination with one or more substitutions at positions 3, 4, 9, 15, 24, 27, 33, 36, 57, 68, 76, 77, 87, 95, 96, 97, 98, 99, 100, 101 , 102, 103, 104, 106, 118, 120, 123, 128, 129, 130, 131, 154, 160, 167, 170, 194, 195, 199, 205, 206, 217, 218, 222, 224, 232, 235, 236, 245, 248, 252 and/or 274 (according to BPN′ numbering) and has proteolytic activity.

In another embodiment, a subtilisin is at least 80% identical to SEQ ID NO: 22 as described in EP 1921147 and is characterized by comprising at least the following amino acids (according to BPN′ numbering) and has proteolytic activity:
(a) threonine at position 3 (3T)
(b) isoleucine at position 4 (4I)
(c) alanine, threonine or arginine at position 63 (63A, 63T, or 63R)
(d) aspartic acid or glutamic acid at position 156 (156D or 156E)
(e) proline at position 194 (194P)
(f) methionine at position 199 (199M)
(g) isoleucine at position 205 (2051)
(h) aspartic acid, glutamic acid or glycine at position 217 (217D, 217E or 217G),
(i) combinations of two or more amino acids according to (a) to (h).

In another embodiment, a subtilisin is at least 80% identical to SEQ ID NO:22 as described in EP 1921147 and is characterized by comprising one amino acid (according to (a)-(h)) or combinations according to (i) together with the amino acid 101E, 101D, 101N, 101Q, 101A, 101G, or 101S (according to BPN′ numbering) and has proteolytic activity.

Especially preferred is subtilisin being at least 80% identical to SEQ ID NO: 22 as described in EP 1921147 and being characterized by comprising the mutation (according to BPN′ numbering) R101E, or S3T+V4I+V205I, S3T+V4I+V199M+V205I+L217D and has proteolytic activity.

In another embodiment, the subtilisin comprises an amino acid sequence having at least 80% identity to SEQ ID NO:22 as described in EP 1921147 and being further characterized by comprising R101E and S3T, V41, and V2171 (according to the BPN′ numbering) and has proteolytic activity.

In another embodiment, a subtilisin comprises an amino acid sequence having at least 80% identical to SEQ ID NO:22 as described in EP 1921147 and being further characterized by comprising R101E, and one or more substitutions selected from the group consisting of S156D, L262E, Q137H, S3T, R45E,D,Q, P55N, T58W,Y,L, Q59D,M,N,T, G61 D,R, S87E, G97S, A98D,E,R, S106A,W, N117E, H120V,D,K,N, S125M, P129D, E136Q, S144W, S161T, S163A,G, Y171L, A172S, N185Q, V199M, Y209W, M222Q, N238H, V244T, N261T,D and L262N,Q,D (as described in WO 2016/096711 and according to the BPN′ numbering) and has proteolytic activity.

Proteases, including serine proteases, according to the invention have “proteolytic activity” or “ protease activity” or “proteolytic activity”. This property is related to hydrolytic activity of a protease (proteolysis, which means hydrolysis of peptide bonds linking amino acids together in a polypeptide chain) on protein containing substrates, e.g. casein, haemoglobin and BSA. Quantitatively, proteolytic activity is related to the rate of degradation of protein by a protease or proteolytic enzyme in a defined course of time. The methods for analyzing proteolytic activity are well-known in the literature (see e.g. Gupta et al. (2002), Appl. Microbiol. Biotechnol. 60: 381-395).

According to the invention, proteolytic activity as such can inter alia be determined by using Succinyl-Ala-Ala-Pro-Phe-p-nitroanilide (Suc-AAPF-pNA, short AAPF; see e.g. DelMar et al. (1979), Analytical Biochem 99, 316-320) as substrate. pNA is cleaved from the substrate molecule by proteolytic cleavage, resulting in release of yellow color of free pNA which can be quantified by measuring OD405. Other methods are known to those skilled in the art.

To determine changes in proteolytic activity over time, the “initial enzymatic activity” of a protease is measured under defined conditions at time cero (100%) and at a certain point in time later (x %). By comparison of the values measured, a potential loss of proteolytic activity can be determined in its extent. The extent of loss reflects the stability or non-stability of the protease.

In one embodiment, the pl value (isoelectric point) of the subtilisin protease may be between pH 7.0 and pH 10.0, for example between pH 8.0 and pH 9.5.

The variants of subtilisin described above can have an amino acid sequence which is at least n % identical to the amino acid sequences described above having serine protease activity with n being an integer between 10 and 100, preferably 10, 15, 20, 25, 30, 35, 40, 45, 50, 55, 60, 65, 70, 75, 80, 85, 90, 91, 92, 93, 94, 95, 96, 97, 98 or 99.

Preferably, the degree of identity is determined by comparing the respective sequence with the amino acid sequence of any one of the above-mentioned subtilisin amino acid sequences. When the sequences which are compared do not have the same length, the degree of identity preferably either refers to the percentage of amino acid residues in the shorter sequence which are identical to amino acid residues in the longer sequence or to the percentage of amino acid residues in the longer sequence which are identical to amino acid residues in the shorter sequence. The degree of sequence identity can be determined according to methods well known in the art using preferably suitable computer algorithms such as CLUSTAL. When using the Clustal analysis method to determine whether a particular sequence is, for instance, 80% identical to a reference sequence default settings may be used or the settings are preferably as follows: Matrix: blosum 30; Open gap penalty: 10.0; Extend gap penalty: 0.05; Delay divergent: 40; Gap separation distance: 8 for comparisons of amino acid sequences. Preferably, the degree of identity is calculated over the complete length of the sequence.

In context with the present invention, the protease (c) may be present in an amount of 0.1 to 4 w/w %, relative to the total weight of the laundry detergent composition, preferably 0.5 to 3 w/w %, or 0.8 to 2 w/w %.

As mentioned, the gist of the present invention lies in the surprising finding that a combination of components (a), (b) and (c) leads to a synergistic effect for cleaning laundry, i.e. for removing stains and soil from laundry (fabrics, textiles) as defined herein. This effect particularly applies to the removal of bleach-sensitive and protease-sensitive stains as described herein and as shown in the examples, even without the addition of bleaching compounds, bleaching agents, bleach activators, bleach catalysts, and/or bleach boosters.

The combination of components (a), (b), and (c) as described and provided herein is generally effective for removing stains from all kinds of laundry and textiles such as, inter alia, Blueberry stains (WFK 10WB), Bill Blueberries Juice unaged (CFT CS-115); Strawberry (Warwick 114KC), Blood/Milk/Ink stains (EMPA117, EMPA116), Blood stains (CFT CS01), Grass/mud stain (CFT-KC-H-080), Grass stain (CFT 008), Ground soil (CFT-KC-H-018), Egg stains (CFT CS37, CFT CS-38), and further including those further defined herein. When determining the removability of given stains from a certain fabric or textile, it is preferred that the removability is determined for stains on cotton as also shown in the examples. That is, in one embodiment of the present invention, the combination of components (a), (b), and (c) as described and provided herein is particularly effective for removal of stains as further defined and described herein from cotton laundry and textiles.

In context with the present invention, the terms “bleach-sensitive stain”, “bleachable stain” or “ bleach-sensitive soil” are used interchangeably and comprise generally oxidisable stains, i.e. stains which can be removed with an oxidizing agent, bleach, (e.g. chlorine, hydrogenperoxide, sodium percarbonate, or peracetic acid). An oxidizing bleach works by breaking the chemical bonds that make up the chromophore. This changes the molecule into a different substance that either does not contain a chromophore, or contains a chromophore that does not absorb visible light. This is the mechanism of bleaches based on chlorine. Inter alia, bleach-sensitive stains in accordance with the present invention comprise stains indicated as “responsive to bleach” according to Warwick Equest Stain Catalogue (Version 7, May 2015) and/or stains according to Swissatest (EMPA) groups 4B or 4C (http://www.testfabrics.com, valid as of Jan. 1, 2016). In context with the present invention, bleach-sensitive stains comprise particularly—but not limited to—those stains derived from or containing fruit or vegetable, preferably fruit stains. In one embodiment of the present invention, bleach-sensitive stains comprise blueberry stains (e.g., Warwick 023 or WFK 10 WB), strawberry stains (e.g., Warwick 114), red cherry stains (e.g., Warwick 101), blueberry juice unaged (e.g., CFT-C-S 115), and grass/mud stains (e.g., CFT-KC-H 080).

In context with the present invention, the term “protease-sensitive stain” or “protease-sensitive soil” are used interchangeably and comprise generally stains comprising substantive amounts of proteins serving as substrates for proteases as defined herein. Inter alia, protease-sensitive stains in accordance with the present invention comprise stains indicated as “responsive to enzyme” according to Warwick Equest Stain Catalgue (Version 7, May 2015) and/or stains according to EMPA stains comprising substantive amounts of proteins (http://www.testfabrics.com, valid as of Jan. 1, 2016). In context with the present invention, protease-sensitive stains comprise particularly—but not limited to—those stains derived from or containing blood, grass, milk, egg, cocoa, chocolate, mousse, or the like. In one embodiment of the present invention, protease-sensitive stains comprise blood stains (e.g., CFT CS01), grass stains (CFT CS08), milk stains (e.g. CFT C11), blood/milk/ink stains (EMPA 116, EMPA 117, CFT CS05), chocolate and chocolate mousse stains (e.g., CFT C-S 70), and cocoa stains (e.g., EMPA 112).

The liquid laundry composition comprising components (a), (b) and (c) as provided and to be employed in context with the present invention may further comprise additional compounds suitable for laundry detergent compositions. Generally, such additional compounds may comprise inter alia builders, structurants or thickeners, clay soil removal/anti-redeposition agents, surfactants, polymeric soil release agents, polymeric dispersing agents, polymeric grease cleaning agents, enzymes, enzyme stabilizing systems, bleaching compounds, bleaching agents, bleach activators, bleach catalysts, bleach boosters, brighteners, dyes, hueing agents, dye transfer inhibiting agents, chelating agents (e.g., others than MGDA), suds supressors, softeners, graying inhibitors, and perfumes. In one embodiment of the present invention, the laundry composition provided and to be employed in context with the present invention does not comprise bleaching compounds, bleaching agents, bleach activators, bleach catalysts, and/or bleach boosters.

The laundry detergent composition provided and to be employed in context with the present invention may further comprise at least one optional ingredient, for example one or more nonionic or ionic (e.g., anionic such as, e.g, linear alkyl benzene sulfonate (LAS), sodium lauryl ether sulphate (SLES)) or non-ionic (e.g., alkylethoxylates)/amphoteric surfactants as known in the art.

Suitable surfactants as part of a laundry detergent formulation of the present invention may be, for example, nonionic surfactants (NIS). The nonionic surfactants used are preferably alkoxylated, advantageously ethoxylated, in particular primary alcohols having preferably 8 to 18 carbon atoms and, on average, 1 to 12 mol of ethylene oxide (EO) per mole of alcohol, in which the alcohol radical can be linear or preferably 2-methyl-branched and/or can comprise linear and methyl-branched residues in a mixture, as customarily present in oxo alcohol residues. In particular, however, preference is given to alcohol ethoxylates with linear or branched residues from alcohols of native or petrochemical origin having 12 to 18 carbon atoms, for example from coconut alcohol, palm alcohol, tallow fat alcohol or oleyl alcohol, and, on average, 2 to 8 EO per mole of alcohol. The preferred ethoxylated alcohols include, for example, C₁₂-C₁₄-alcohols with 3 EO, 5 EO, 7 EO or 9 EO, C₉-C₁₁-alcohol with 7 EO, C₁₃-C₁₅-alcohols with 3 EO, 5 EO, 7 EO or 9 EO, C₁₂-C₁₈-alcohols with 3 EO, 5 EO, 7 EO or 9 EO and mixtures of these, such as mixtures of C₁₂-C₁₄-alcohol with 3 EO and C₁₂-C₁₈-alcohol with 7 EO, 2 propylheptanol with 3 to 9 EO. Mixtures of short-chain alcohol ethoxylates (e.g. 2-propylheptanol×7 EO) and long-chain alcohol ethoxylates (e.g. C16,18×7 EO). The stated degrees of ethoxylation are statistical average values (number-average, Mn) which can be an integer or a fraction for a specific product. Preferred alcohol ethoxylates have a narrowed homolog distribution (narrow range ethoxylates, NRE). In addition to these nonionic surfactants, fatty alcohols with more than 12 EO can also be used. Examples thereof are tallow fatty alcohol with 14 EO, 25 EO, 30 EO or 40 EO. It is also possible to use nonionic surfactants which comprise ethylene oxide (EO) and propylene oxide (PO) groups together in the molecule. In this context, it is possible to use block copolymers having EO-PO block units or PO-EO block units, but also EO-PO-EO copolymers or PO-EO-PO copolymers. It is of course also possible to use nonionic surfactants with mixed alkoxylation, in which EO and PO units are not distributed blockwise, but randomly. Such products are obtainable by the simultaneous action of ethylene oxide and propylene oxide on fatty alcohols.

In addition, as further nonionic surfactants, in accordance with the invention, it is also possible to use alkyl glycosides of the general formula (V)

R¹⁰O(G)ᵢ (V)

in which R¹⁰ is a primary straight-chain or methyl-branched, in particular 2-methyl-branched, aliphatic radical having 8 to 22, preferably 12 to 18 carbon atoms, and G is a glycoside unit having 5 or 6 carbon atoms, preferably glucose. The degree of oligomerization i, which indicates the distribution of monoglycosides and oligoglycosides, is any desired number between 1 and 10; preferably i is 1.2 to 1.4.

In the context of the present invention, a further class of nonionic surfactants used with preference, which are used either as the sole nonionic surfactant or in combination with other nonionic surfactants, is that of alkoxylated, preferably ethoxylated or ethoxylated and propoxylated fatty acid alkyl esters, preferably having 1 to 4 carbon atoms in the alkyl chain, in particular fatty acid methyl esters, as described, for example, in the Japanese patent application JP 58/217598 or which are preferably prepared by the process described in the international patent application WO 90/13533. Nonionic surfactants of the amine oxide type, for example N-cocoalkyl-N,N-dimethylamine oxide and N-tallow-alkyl-N,N-dihydroxyethylamine oxide, and the fatty acid alkanolamides may also be suitable in this context. The amount (weight) of these nonionic surfactants is preferably not more than that of the ethoxylated fatty alcohols, especially not more than half thereof.

Further suitable surfactants comprise, in accordance with the invention, polyhydroxy fatty acid amides of formula (VI)

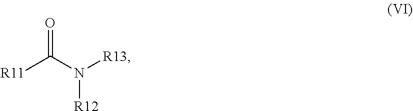

in which R11C(═O) is an aliphatic acyl radical having 6 to 22 carbon atoms, R12 is hydrogen, an alkyl or hydroxyalkyl radical having 1 to 4 carbon atoms and R13 is a linear or branched polyhydroxyalkyl radical having 3 to 10 carbon atoms and 3 to 10 hydroxyl groups. The polyhydroxy fatty acid amides are known substances which can typically be obtained by reductive amination of a reducing sugar with ammonia, an alkylamine or an alkanolamine and subsequent acylation with a fatty acid, a fatty acid alkyl ester or a fatty acid chloride. The group of the polyhydroxy fatty acid amides also includes compounds of the formula (VII) in this context

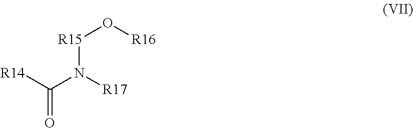

in which R14 is a linear or branched alkyl or alkenyl radical having 7 to 12 carbon atoms, R15 is a linear, branched or cyclic alkylene radical having 2 to 8 carbon atoms or an arylene radical having 6 to 8 carbon atoms and R16 is a linear, branched or cyclic alkyl radical or an aryl radical or an oxyalkyl radical having 1 to 8 carbon atoms, where C₁-C₄-alkyl or phenyl residues are preferred, and R17 is a linear polyhydroxyalkyl radical whose alkyl chain is substituted with at least two hydroxyl groups, or alkoxylated, preferably ethoxylated or propoxylated, derivatives of this radical. R17 is preferably obtained by reductive amination of a sugar, for example glucose, fructose, maltose, lactose, galactose, mannose or xylose. The N-alkoxy- or N-aryloxy-substituted compounds can then be converted to the desired polyhydroxy fatty acid amides, for example, according to WO 95/07331 by reaction with fatty acid methyl esters in the presence of an alkoxide as a catalyst

Surfactants may, in accordance with the invention, also be anionic surfactants. In the context of the present invention, the anionic surfactants used may be those of the sulfonate and sulfate type, for example. Suitable surfactants of the sulfonate type are preferably C₉-C₁₃-alkylbenzenesulfonates, olefinsulfonates, i.e. mixtures of alkene- and hydroxyalkanesulfonates, and also disulfonates, as obtained, for example, from C₁₂-C₁₈-monoolefins with terminal or internal double bond by sulfonation with gaseous sulfur trioxide and subsequent alkaline or acidic hydrolysis of the sulfonation products. Also suitable are alkane sulfonates which are obtained from C₁₂-C₁₈-alkanes, for example by sulfochlorination or sulfoxidation with subsequent hydrolysis or neutralization. Likewise, the esters of α-sulfo fatty acids (ester sulfonates), for example the α-sulfonated methyl esters of hydrogenated coconut, palm kernel or tallow fatty acids, are also suitable. Further suitable anionic surfactants may, in accordance with the invention, be sulfated fatty acid glycerol esters. Fatty acid glycerol esters are to be understood to mean, inter alia, mono-, di- and triesters, and mixtures thereof, as obtained in the preparation by esterification of a monoglycerol with 1 to 3 mol of fatty acid or during the transesterification of triglycerides with 0.3 to 2 mol of glycerol. Preferred sulfated fatty acid glycerol esters here are the sulfation products of saturated fatty acids having 6 to 22 carbon atoms, for example of caproic acid, caprylic acid, capric acid, myristic acid, lauric acid, palmitic acid, stearic acid or behenic acid.

The alk(en)yl sulfates are preferably the alkali metal and in particular the sodium salts of the sulfuric acid half-esters of C₁₂-C₁₈-fatty alcohols, for example of coconut fatty alcohol, tallow fatty alcohol, lauryl alcohol, myristyl alcohol, cetyl alcohol or stearyl alcohol or of the C₁₀-C₂₀-oxo alcohols and those half-esters of secondary alcohols of these chain lengths. Furthermore, preference is given to alk(en)yl sulfates of the specified chain length which comprise a synthetic, petrochemical-based straight-chain alkyl radical which have analogous degradation behavior to the appropriate compounds based on oleochemical raw materials. From a washing point of view, the C₁₂-C₁₆-alkyl sulfates and C₁₂-C₁₅-alkyl sulfates and also C₁₄-C₁₅-alkyl sulfates are preferred. 2,3-Alkyl sulfates, which are prepared, for example, in accordance with the US patent specifications U.S. Pat. Nos. 3,234,258 or 5,075,041 and can be obtained as commercial products from the Shell Oil Company under the name DAN®, are also suitable anionic surfactants. Also suitable are the sulfuric monoesters of the straight-chain or branched C₇-C₂₁-alcohols ethoxylated with 1 to 6 mol of ethylene oxide, such as 2-methyl-branched C₉-C₁₁-alcohols with on average 3.5 mol of ethylene oxide (EO) or C₁₂-C₁₈-fatty alcohols with 1 to 4 EO, inter alia. On account of their high foaming propensity, they are typically used in cleaning compositions only in relatively small amounts, for example in amounts of 1 to 5 wt %. In the context of the present invention, further suitable anionic surfactants are also the salts of alkylsulfosuccinic acid, which are also referred to as sulfosuccinates or as sulfosuccinic acid esters and which constitute monoesters and/or diesters of sulfosuccinic acid with alcohols, preferably fatty alcohols and in particular ethoxylated fatty alcohols. Preferred sulfosuccinates comprise C₈-C₁₈-fatty alcohol residues or mixtures thereof. Particularly preferred sulfosuccinates comprise a fatty alcohol radical derived from ethoxylated fatty alcohols. In this connection, particular preference is in turn given to sulfosuccinates whose fatty alcohol residues are derived from ethoxylated fatty alcohols with a narrow homolog distribution. It is likewise also possible to use alk(en)ylsuccinic acid having preferably 8 to 18 carbon atoms in the alk(en)yl chain or salts thereof.

Particularly preferred anionic surfactants are soaps. Saturated and unsaturated fatty acid soaps, such as the salts of lauric acid, myristic acid, palmitic acid, stearic acid, (hydrogenated) erucic acid and behenic acid, and also soap mixtures derived in particular from natural fatty acids, for example coconut, palm kernel, olive oil or tallow fatty acids, are suitable.

The anionic surfactants including the soaps can be present in accordance with the invention in the form of their sodium, potassium or ammonium salts, and also as soluble salts of organic bases, such as mono-, di- or triethanolamine. Preferably, the anionic surfactants are present in the form of their sodium or potassium salts, in particular in the form of the sodium salts.

In the context of the present invention, the surfactants used may also be cationic surfactants. Particularly suitable cationic surfactants that may be mentioned here, for example, are:
C₇-C₂₅-alkylamines;
N,N-dimethyl-N-(hydroxy-C₇-C₂₅-alkyl)ammonium salts;
mono- and di(C₇-C₂₅-alkyl)dimethylammonium compounds quaternized with alkylating agents;
ester quats, in particular quaternary esterified mono-, di- and trialkanolamines which are esterified with C₈-C₂₂-carboxylic acids;
imidazoline quats, in particular 1-alkylimidazolinium salts of formulae VIII or IX

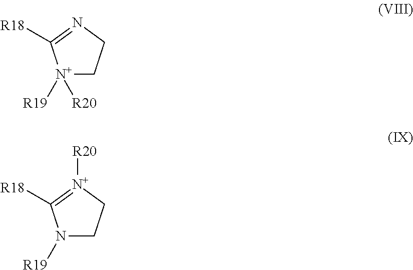

where the variables are each defined as follows:

R18 C₁-C₂₅-alkyl or C₂-C₂₅-alkenyl;

R19 C₁-C₄-alkyl or hydroxy-C₁-C₄-alkyl;

R20 C₁-C₄-alkyl, hydroxy-C₁-C₄-alkyl or a R₁—(CO)—R²¹—(CH₂)ⱼ—(R²¹:—O— or —NH—; j: 2 or 3) radical, where at least one R18 radical is a C₇-C₂₂-alkyl.

In the context of the present invention, the surfactants may also be amphoteric surfactants. Suitable amphoteric surfactants here are, e.g. alkyl betaines, alkylamide betaines, aminopropionates, aminoglycinates and amphoteric imidazolium compounds.

The content of surfactants in laundry detergent compositions of the invention in liquid and gel form may be, e.g.,2 to 75 w/w % and in particular 5 to 65 w/w %, based in each case on the overall composition.

The content of surfactants in solid laundry detergent compositions of the invention may be, e.g., 2 to 40 w/w % and in particular 5 to 35 w//wt %, based in each case on the overall composition.

In the context of the present invention, suitable builders, co-builders and complexing agents may be part of the laundry detergent composition described and provided herein and include inorganic builders such as:
crystalline and amorphous aluminosilicates with ion-exchanging properties, such as in particular zeolites: Various types of zeolites are suitable, especially zeolites A, X, B, P, MAP and HS in the sodium form thereof, or in forms in which Na has been partially exchanged for other cations such as Li, K, Ca, Mg or ammonium.
crystalline silicates, such as in particular disilicates and sheet silicates, e.g. δ- and β-Na₂Si₂O₅. The silicates can be used in the form of their alkali metal, alkaline earth metal or ammonium salts, preference being given to the Na, Li and Mg silicates;
amorphous silicates, such as sodium metasilicate and amorphous disilicate;
carbonates and hydrogen carbonates: These can be used in the form of their alkali metal, alkaline earth metal or ammonium salts. Preference is given to Na, Li and Mg carbonates and hydrogen carbonates, in particular sodium carbonate and/or sodium hydrogen carbonate; and
polyphosphates, such as pentasodium triphosphate.

In the context of the present invention, suitable co-builders and complexing agents (C_{L} or C_{F}) include:
low molecular weight carboxylic acids such as citric acid, hydrophobically modified citric acid, e.g. agaric acid, malic acid, tartaric acid, gluconic acid, glutaric acid, succinic acid, imidodisuccinic acid, oxydisuccinic acid, propanetricarboxylic acid, butanetetracarboxylic acid, cyclopentanetetracarboxylic acid, alkyl- and alkenylsuccinic acids and aminopolycarboxylic acids, e.g. nitrilotriacetic acid, β-alaninediacetic acid, ethylenediaminetetraacetic acid, serinediacetic acid, isoserinediacetic acid, N-(2-hydroxyethyl)iminoacetic acid, ethylenediaminedisuccinic acid, glutamic acid diacetic acid and methyl- and ethylglycinediacetic acid or alkali metal salts thereof;
oligomeric and polymeric carboxylic acids, such as homopolymers of acrylic acid, copolymers of acrylic acid with sulfonic acid group-containing comonomers such as 2-acrylamido2-methylpropanesulfonic acid (AMPS), allylsulfonic acid and vinylsulfonic acid, oligomaleic acids, copolymers of maleic acid with acrylic acid, methacrylic acid or C₂-C₂₂-olefins, e.g. isobutene or long chain α-olefins, vinyl-C₁-C₈-alkyl ethers, vinyl acetate, vinyl propionate, (meth)acrylic esters of C₁-C₈-alcohols and styrene. Preference is given to the homopolymers of acrylic acid and copolymers of acrylic acid with maleic acid or AMPS. The oligomeric and polymeric carboxylic acids are used in acid form or as the sodium salt;
phosphonic acids such as 1-hydroxyethylene(1,1-diphosphonic acid), aminotri(methylenephosphonic acid), ethylenediaminetetra(methylenephosphonic acid) and diethylenetriaminepenta(methylenephosphonic acid) and alkali metal salts thereof.

Customary ingredients for laundry detergent compositions are known to those skilled in the art and comprise, for example, alkali carriers, defoamers, dyes, fragrances, perfume carriers, graying inhibitors, dye transfer inhibitors, color protection additives, fiber protection additives, optical brighteners, soil release polyesters, corrosion inhibitors, bactericides and preservatives, organic solvents, solubilizers, pH modifiers, hydrotropes, thickeners, rheology modifiers and/or alkanolamines for liquid or gel-type cleaning or detergent compositions, or modifiers (e.g. sodium sulfate), defoamers, dyes, fragrances, perfume carriers, graying inhibitors, dye transfer inhibitors, color protection additives, fiber protection additives, optical brighteners, soil release polyesters, corrosion inhibitors, bactericides and preservatives, dissolution promoters, disintegrants, process auxiliaries and/or water for solid laundry detergent compositions.

Suitable graying inhibitors are, for example, carboxymethylcellulose, graft polymers of vinyl acetate on polyethylene glycol, and alkoxylates of polyethyleneimine.

As thickeners, so-called associative thickeners may be used. Suitable examples of thickeners are known to those skilled in the art and are described, inter alia, in WO 2009/019225 A2, EP 013 836 or WO 2006/016035.

In the context of the present invention, optical brighteners (called “whiteners”) can be added to the liquid laundry detergent compositions in order to eliminate graying and yellowing of the treated textile fabrics. These substances attach to the fibers and bring about a brightening and simulated bleaching effect by converting invisible ultraviolet radiation to visible longer-wave light, with emission of the ultraviolet light absorbed from the sunlight as pale bluish fluorescence to give pure white with the yellow shade of grayed and/or yellowed laundry. Suitable compounds originate, for example, from the substance classes of the 4,4′-diamino-2,2′-stilbenedisulfonic acids (flavonic acids), 4,4′-distyrylbiphenylene, methylumbelliferones, coumarins, dihydroquinolinones, 1,3-diarylpyrazolines, naphthalimides, benzoxazole, benzisoxazole and benzimidazole systems, and the pyrene derivatives substituted by heterocycles. The optical brighteners are typically used in amounts between 0.03 and 0.3 wt %, based on the finished composition.

Suitable dye transfer inhibitors are, in accordance with the invention, for example, homopolymers, copolymers and graft polymers of 1-vinylpyrrolidone, 1-vinylimidazole or 4-vinylpyridine N-oxide. Homopolymers and copolymers of 4-vinylpyridine reacted with chloroacetic acid are also suitable as dye transfer inhibitors.

Detergent ingredients are otherwise generally known. Detailed descriptions can be found, for example, in WO 99/06524 and WO 99/04313; in Liquid Detergents, Editor: Kuo-Yann Lai, Surfactant Sci. Ser., Vol. 67, Marcel Decker, New York, 1997, pp. 272-304. Further detailed descriptions of the detergent and cleaning composition ingredients can be found, for example, in: Handbook of Detergents, Part D: Formulation, Surfactant Sci Ser, Vol. 128, Editor: Michael S. Showell, CRC Press 2006; Liquid Detergents sec. edition, Surfactant Sci Ser, Vol. 129, Editor: Kuo-Yann Lai, CRC Press 2006; or Waschmittel: Chemie, Umwelt, Nachhaltigkeit [Detergents: Chemistry, Environment, Sustainability], Günter Wagner, Wiley-VCH Verlag GmbH & Co. KGaA, August 2010.

Examples of suitable amphoteric surfactants to be employed in the laundry detergent composition as described and provided herein comprise those that bear a positive and a negative charge in the same molecule under use conditions. Preferred examples of amphoteric surfactants comprise so-called betaine-surfactants. Many examples of betaine-surfactants bear one quaternized nitrogen atom and one carboxylic acid group per molecule. A particularly preferred example of amphoteric surfactants that can be used in accordance with the present invention is cocamidopropyl betaine (lauramidopropyl betaine).

Examples of amine oxide surfactants are compounds of the general formula (V)

R¹³R14⁸R¹⁵N→O (V)

wherein R¹³, R¹⁴ and R¹⁵ are selected independently from each other from aliphatic, cycloaliphatic or C₂-C₄-alkylene C₁₀-C₂₀-alkylamido moieties. Preferably, R¹³ is selected from C₈-C₂₀-alkyl or C₂-C₄-alkylene C₁₀-C₂₀-alkylamido and R¹⁴ and R¹⁵ are both methyl.

A particularly preferred example is lauryl dimethyl aminoxide, sometimes also called lauramine oxide. A further particularly preferred example is cocamidylpropyl dimethylaminoxide, sometimes also called cocamidopropylamine oxide.

Further optional ingredients to the laundry detergent composition as described and provided in accordance with the present invention may be but are not limited to sodium carbonate, sodium sulfate, bleaching agents, bleach catalysts, bleach activators, viscosity modifiers, cationic surfactants, corrosion inhibitors, amphoteric surfactants, foam boosting or foam reducing agents, enzymes other than proteases (b), perfumes, dyes, optical brighteners, dye transfer inhibiting agents and preservatives.

Laundry detergent compositions according to the present invention may further comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol. In one embodiment of the present invention, laundry compositions according to the invention comprise in total in the range from 0.1 to 1.5% by weight of corrosion inhibitor.

In addition to builder (a) as defined and described herein, the laundry detergent compositions according to the present invention may further comprise one or more additional builders, for example sodium sulfate or sodium carbonate.

Generally, the laundry detergent composition comprising components (a), (b) and (c) as provided and to be employed in context with the present invention may have suitable form, inter alia, those selected from the group consisting of liquid, gel, powder, single-phase or multi-phase unit dose, pouch, tablet, gel, paste, bar, or flake. In one embodiment of the present invention, the laundry composition has liquid or gel form, particularly liquid form.

Further components of the respective laundry compositions may depend on the respective form of the composition. For example, liquid compositions may inter alia further comprise water, surfactants (e.g. as also described and exemplified herein), preservatives, perfumes, and others as known in the art and as also described and exemplified herein. Monodose compositions such as those listed above may inter alia further include water and others, and powder compositions may inter alia further include builder (zeolith carbonate, sulfate, etc.) as known in the art and as also described and exemplified herein. In one embodiment, such compositions do not comprise bleaching compounds, bleaching agents, bleach activators, bleach catalysts, and/or bleach boosters.

In one embodiment of the present invention, the laundry composition may have a pH value in the range of from 7.5 to 11.5, preferably 7.5 to 8.5, particularly for liquid laundry detergent compositions and pH 9 to 11.5 for powder detergents and ADW detergent tabs

The temperatures during laundry washing may be higher (particularly for I&I purposes), i.e. 60° C. or more, or lower (particularly for home care laundry), i.e. 60° C. or less. For example, the temperature may be 20 to 60° C., preferably 20 to 50, more preferably 20 to 40° C. The present invention is further illustrated by the following examples, however, without being limited by the embodiments and specifications defined therein.

### EXAMPLES

Application Test for Washing Machine

The washing performance for the selected compositions was determined as follows.

The soiled swatches are washed together with cotton ballast fabric (3.5 kg) and 1 soil ballast sheet wfk SBL 2004 in a Miele Household washing machine with cotton program 20° C. After the wash the fabrics are dried in the air.

The washing performance for the single stains is determined by measuring the remission value of the soiled fabric after wash with the spectrophotometer from Fa. Datacolor (Elrepho 2000) at 460 nm. The protease sensitive stains from the multisoil monitor are measured with a MACH 5 from CFT/Colour consult. The higher the value, the better the performance.

Washing conditions:

| | |
|---|---|
| Test equipment | Miele W1935 WPSWTL |
| Washing program | Cotton 20° C., 1200 U/min. |
| Dosage | 75 ml Testformulation ES1⁵⁾ |
| Washing cycles | 1 |
| Water hardness | 2.5 mmol/l Ca²⁺:Mg²⁺:HCO₃₋ 4:1:8 |
| Ballast fabric | 3.5 kg cotton towels |
| | 1 SBL 2004 ³⁾ |
| Soiled fabric | Warwick equest 023 KC ¹⁾ Blueberry |
| | Warwick equest 101 KC ¹⁾ Red cherry |
| | Warwick equest 114 KC ¹⁾ Strawberry |
| | wfk 10 WB ²⁾ Blueberry juice |
| | CFT C-S-115 ³⁾ Blueberry juice, unaged |
| | CFT KC-H 080 ³⁾ Grass/mud |
| | CFT C-S-70 ³⁾ Chocolate mousse/cream |
| | EMPA 112 ⁴⁾ Cocoa |
| | EMPA 117 ⁴⁾ Blood, milk, ink |

¹⁾ Producer: Warwick Equest Limited, Consett, County Durham.
DH8 6BN. England
²⁾ Producer: wfk Testgewebe GmbH, 41379 Brüggen, Deutschland
³⁾ Producer: Center for Testmaterials By, 3130 AC Vlaardingen,
the Netherlands
⁴⁾ Producer: EMPA Testmaterialien AG, Sankt Gallen, Schweiz
⁵⁾Testformulation ES1 comprising (in addition to the additives
MGDA, polymer (b1), polymer (b2), subtilisin according to the
tables below):

| | Active Matter | weight in % | |
|---|---|---|---|
| | (concentration) | (relative | weight |
| Testformulation ES1 | in % | to ES1) | in g |
| water | ad | ad | ad |
| KOH | 50% | 1.50% | 3.0 |
| Linear C₁₀C₁₃ alkylben- | 97% | 5.64% | 5.8 |
| zolsulfonic acid | | | |
| C₁₂C₁₈ Coconut fatty acid | 100% | 2.38% | 2.4 |
| C₁₂C₁₄ Fatty alcohol ether | 70% | 5.42% | 7.7 |
| sulfate with 2 EO | | | |
| C₁₃C₁₅ Oxoalcohol | 100% | 5.42% | 5.4 |
| ethoxylate with 7 EO | | | |
| 1,2 Propandiol | 100% | 6.00% | 6.0 |
| Ethanol pure | 100% | 2.00% | 2.0 |

Washing Results

% Remission (R460) for bleach sensitive stains

| | | | | Warwick | | CFT-C-S-115 | | |
|---|---|---|---|---|---|---|---|---|
| | Dosage | Warwick | Warwick | 101 KC | wfk 10 | Blueberry | | |
| | Additive | 023 KC | 114 KC | Red | WB | Juice | CFT-KC-H080 | Sum |
| Additive to ES1 | [w/w %]* | Blueberry | Strawberry | Cherry | Blueberry | unaged | Grass/mud | R460 |
| without | | 30.6 | 25.5 | 19.7 | 18.5 | 25.6 | 31.9 | 151.7 |
| MGDA | 6 | 32.5 | 26.7 | 21.2 | 21.2 | 27.7 | 32.2 | 161.3 |
| Polymer (b1) | 3 | 32.6 | 30.3 | 22.5 | 23.2 | 26.8 | 32.0 | 167.5 |
| Polymer (b2) | 3 | 33.0 | 28.4 | 24.4 | 23.4 | 27.1 | 32.6 | 168.8 |
| Subtilisin | 1 | 31.7 | 25.9 | 24.2 | 19.2 | 25.4 | 33.7 | 160.1 |
| MGDA Polymer (b1) | 6 + 3 | 36.6 | 32.0 | 26.7 | 27.3 | 31.7 | 36.0 | 190.3 |
| MGDA + Polymer (b2) | 6 + 3 | 41.1 | 29.3 | 28.2 | 27.6 | 31.7 | 37.2 | 195.0 |
| MGDA + Subtilisin | 6 + 1 | 45.5 | 27.9 | 27.7 | 25.6 | 31.5 | 38.7 | 196.9 |
| Polymer (b1) + Subtilisin | 3 + 1 | 44.0 | 32.6 | 26.0 | 26.4 | 30.7 | 39.3 | 199.0 |
| Polymer (b2) + Subtilisin | 3 + 1 | 42.8 | 29.6 | 25.1 | 24.9 | 30.4 | 38.9 | 191.7 |
| MGDA + Polymer (b1) + | 6 + 3 + 1 | 46.4 | 33.6 | 29.7 | 29.1 | 33.6 | 39.5 | 211.9 |
| Subtilisin | | | | | | | | |
| MGDA + Polymer (b2) + | 6 + 3 + 1 | 46.7 | 30.7 | 29.8 | 28.1 | 32.4 | 40.2 | 207.9 |
| Subtilisin | | | | | | | | |

*relative to total composition
Without: Without addition of builder (a), polymer (b), and protease (c) according to this invention
Polymer (b1): Ethoxylated polyethylenimine M_{W} ~12,000-14,000 (PEI core ~600-800), 20 EO/NH
Polymer (b2): Ethoxylated hexamethylene diamine M_{W} ~4,500, 24 EO/NH

Y value for protease sensitive stains

| | Dosierung | | | | |
|---|---|---|---|---|---|
| | Additiv | EMPA | CFT C- | EMPA | Sum |
| Additive to ES1 | [w/w %] | 117 | S-70 | 112 | Y |
| without | | 34.2 | 48.8 | 48.9 | 131.9 |
| MGDA | 6 | 37.2 | 53.3 | 52.1 | 142.5 |
| Polymer (b1) | 3 | 34.1 | 54.3 | 50.5 | 138.9 |
| Polymer (b2) | 3 | 34.1 | 54.2 | 49.7 | 138.1 |
| Subtilisin | 1 | 52.6 | 62.3 | 59.7 | 174.6 |
| MGDA + Polymer (b1) | 6 + 3 | 38.0 | 59.4 | 54.4 | 151.8 |
| MGDA + Polymer (b2) | 6 + 3 | 36.8 | 51.8 | 51.6 | 140.2 |
| MGDA + Subtilisin | 6 + 1 | 57.4 | 64.4 | 61.5 | 183.3 |
| Polymer (b1) + | 3 + 1 | 53.0 | 65.2 | 62.6 | 180.8 |
| Subtilisin | | | | | |
| Polymer (b2) + | 3 + 1 | 52.7 | 61.2 | 60.8 | 174.8 |
| Subtilisin | | | | | |
| MGDA + | 6 + 3 + 1 | 57.1 | 73.3 | 64.4 | 194.7 |
| Polymer (b1) + | | | | | |
| Subtilisin | | | | | |
| MGDA + | 6 + 3 + 1 | 58.0 | 69.6 | 62.3 | 189.9 |
| Polymer (b2) + | | | | | |
| Subtilisin | | | | | |

* relative to total composition
Without: Without addition of builder (a), polymer (b), and protease (c) according to this invention
Polymer (b1): Ethoxylated polyethylenimine Mw~12,000-14,000 (PEI core~600-800), 20 EO/NH
Polymer (b2): Ethoxylated hexamethylene diamine Mw~4,500, 24 EO/NH

1. A method for removing stain or soil from laundry, comprising contacting the laundry with a laundry detergent composition comprising:
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid,
and the respective salts thereof;
(b) a polymer which is
(b1) an ethoxylated polyethylenimine with an average molecular weight M_{w} in the range from 5,000 to 250,000 g/mol which has 80 to 99% by weight ethylene oxide side chains, based on total ethoxylated polyethylenimine, and/or
(b2) a polymer which is an ethoxylated hexamethylene diamine, quaternized and optionally sulfated with an average molecular weight M_{w} in the range from 2,000 to 10,000 g/mol, and mixtures thereof; and
(c) a protease.

2. (canceled)

3. A laundry detergent composition for removing stain or soil from laundry, said composition comprising:
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid,
and the respective salts thereof;
(b) a polymer which is
(b1) an ethoxylated polyethylenimine with an average molecular weight M_{w} in the range from 5,000 to 250,000 g/mol which has 80 to 99% by weight ethylene oxide side chains, based on total ethoxylated polyethylenimine, and/or
(b2) a polymer which is an ethoxylated hexamethylene diamine, quaternized and optionally sulfated with an average molecular weight M_{w} in the range from 2,000 to 10,000 g/mol, and mixtures thereof; and
(c) a protease.

4. A method of improving stain-removal ability of a protease in laundry detergent compositions, said method comprising the step of adding
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid,
and the respective salts thereof; and
(b) a polymer which is
(b1) an ethoxylated polyethylenimine with an average molecular weight M_{w} in the range from 5,000 to 250,000 g/mol which has 80 to 99% by weight ethylene oxide side chains, based on total ethoxylated polyethylenimine, and/or
(b2) a polymer which is an ethoxylated hexamethylene diamine, quaternized and optionally sulfated with an average molecular weight M_{w} in the range from 2,000 to 10,000 g/mol, and mixtures thereof; and
to said protease.

5. (canceled)

6. A method of preparing a laundry detergent composition as provided and defined herein, comprising mixing
(a) at least one builder or co-builder which is an aminocarboxylate selected from the group consisting of methylglycine diacetate (MGDA), iminodisuccinic acid (IDS), glutamic acid diacetate (GLDA), ethylenediaminedisuccinic acid (EDDS), polyasparatic acid,
and the respective salts thereof;
(b) a polymer which is
(b1) an ethoxylated polyethylenimine with an average molecular weight M_{w} in the range from 5,000 to 250,000 g/mol which has 80 to 99% by weight ethylene oxide side chains, based on total ethoxylated polyethylenimine, and/or
(b2) a polymer which is an ethoxylated hexamethylene diamine, quaternized and optionally sulfated with an average molecular weight M_{w} in the range from 2,000 to 10,000 g/mol, and mixtures thereof; and
(c) a protease
in one or more steps.

7. The method according to claim 1, wherein said aminocarboxylate is MGDA.

8. The method according to claim 1, wherein said protease is subtilisin.

9. The method according to claim 1, wherein said stain is a bleach-sensitive stain or a protease-sensitive stain.

10. The method according to claim 1, wherein said stain is a bleach-sensitive stain.

11. The method according to claim 1, wherein said composition is in liquid form.

12. The method according to claim 1, wherein the builder (a) is present in an amount of 0.1 to 25.0 w/w %, relative to the total weight of the laundry detergent composition.

13. The method according to claim 1, wherein the polymer (b) is present in an amount of 0.1 to 10 w/w %, relative to the total weight of the laundry detergent composition.

14. The method according to claim 1, wherein the protease (c) is present in an amount of 0.1 to 4 w/w %, relative to the total weight of the laundry detergent composition.

15. The composition according to claim 3, wherein said aminocarboxylate is MGDA.

16. The composition according to claim 3, wherein said protease is subtilisin.

17. The composition according to claim 3, wherein said stain is a bleach-sensitive stain or a protease-sensitive stain.

18. The composition according to claim 3, wherein said stain is a bleach-sensitive stain.

19. The composition according to claim 3, wherein said composition is in liquid form.

20. The composition according to claim 3, wherein the builder (a) is present in an amount of 0.1 to 25.0 w/w %, relative to the total weight of the laundry detergent composition.

21. The composition according to claim 3, wherein the polymer (b) is present in an amount of 0.1 to 10 w/w %, relative to the total weight of the laundry detergent composition.

22. The composition according to claim 3, wherein the protease (c) is present in an amount of 0.1 to 4 w/w %, relative to the total weight of the laundry detergent composition.
